(19) United States
(12) Patent Application Publication
(10) Pub. No.: US 2023/0367010 A1
(43) Pub. Date: Nov. 16, 2023

(54) LIGHT SENSOR AND CONTROL METHOD THEREOF

(71) Applicant: SENSORTEK TECHNOLOGY CORP., Hsinchu County (TW)

(72) Inventors: Yu-Min Lin, Hsinchu County (TW); Feng-Jung Hsu, Hsinchu County (TW)

(21) Appl. No.: 18/100,716

(22) Filed: Jan. 24, 2023

Related U.S. Application Data
(60) Provisional application No. 63/267,066, filed on Jan. 24, 2022.

(51) Int. Cl. G01S 17/32; G01S 17/04; G01S 7/48

(52) U.S. Cl. CPC G01S 17/32; G01S 17/04; G01S 7/4802

(57) ABSTRACT

A light sensor and a control method thereof are disclosed. The light sensor comprises a light-emitting element, a first light-sensing unit and a second light-sensing unit. The light-emitting element generates an emission signal. The light-sensitive characteristic of the first light-sensing unit corresponds to a first wavelength range. The light-sensitive characteristic of the second light-sensing unit corresponds to a second wavelength range, which is different from the first wavelength range. In this way, when the emission signal is reflected by an object and received by the first light-sensing unit and the second light-sensing unit, the type of the object may be determined based on the difference between the signal sensed by the first light-sensing unit and the signal sensed by the second light-sensing unit.

### FIELD OF THE INVENTION

The present application is related to a light sensor and a control method thereof, in particular to the light sensor and the control method capable of judging the proximity and the type of an object.

### BACKGROUND OF THE INVENTION

Light sensors using the light sensing technology are applied massively to many applications. For example, a proximity sensor may be used to detect the distance between an object and an electronic device, such as a smartphone or wireless Bluetooth earphones. Thereby, when the proximity sensor is close to a user's face, the smartphone may shut off the display and touch functions correspondingly for avoiding interruption due to unintentional touches by the user's face. In addition, when the proximity sensor is away from the user's face, the earphones may shut off audio or microphone function for saving power.

In general, current proximity sensors are usually adopted with light-emitting diodes or laser diodes for emitting light. When the light is emitted to an approaching object, the intensity of the reflected light is used to judge the distance to the object. Unfortunately, the intensity of the reflected light cannot be used to judge the type of the object directly. If to do so, for example, to judge if the human skin is approaching, additional sensors must be used to provide more information. By using a capacitance sensor or a temperature sensor, a system may judge if the approaching object is human skin. Nonetheless, this method requires additional sensors and increases the overall cost. Thereby, most commercial electronic devices do not identify the type of the approaching objects by light sensors.

Accordingly, light sensors indeed should be improved so that electronic devices may be implemented with more accuracy and more control functions at lower costs.

### SUMMARY OF THE INVENTION

An objective of the present application is to provide a light sensor and a control method thereof. By disposing a plurality of light-sensing units having light-sensing characteristics corresponding to different wavelength ranges, the type of an object may be judged according to the differences between the signals sensed by the light-sensing units.

The present application provides a light sensor, which comprises a light-emitting device, a first light-sensing unit, and a second light-sensing unit. The light-emitting device generates an emitted signal. The first light-sensing unit has light-sensing characteristics corresponding to a first wavelength range. The second light-sensing unit has light-sensing characteristics corresponding to a second wavelength range. The second wavelength range is different from the first wavelength range. When the emitted signal is reflected by an object and received by the first light-sensing unit and the second light-sensing unit, a control unit judges the type of the object according to the difference between the signal sensed by the first light-sensing unit and the signal sensed by the second light-sensing unit.

The present application provides a control method for a light sensor, which controls the operation of the light sensor containing a light-emitting device, a first light-sensing unit, and a second light-sensing unit. The first light-sensing unit has light-sensing characteristics corresponding to a first wavelength range. The second light-sensing unit has light-sensing characteristics corresponding to a second wavelength range. The first wavelength range is different from the second wavelength range. A control unit controls the light-emitting device to emit the emitted signal and receives the signals sensed by the first light-sensing unit and the second light-sensing unit. When the emitted signal is reflected by an object and received by the first light-sensing unit and the second light-sensing unit, the control unit judges the type of the object according to the difference between a sensed signal of the first light-sensing unit and a sensed signal of the second light-sensing unit.

### BRIEF DESCRIPTION OF DRAWINGS

FIG. 1 shows a schematic diagram of the architecture of the light sensor and the control method thereof according to the first embodiment of the present application;

FIG. 2 shows a schematic diagram of the wavelength response of the light sensor and the control method thereof according to the first embodiment of the present application;

FIG. 3 shows a schematic diagram of the architecture of the light sensor and the control method thereof according to the second embodiment of the present application;

FIG. 4 shows a schematic diagram of the wavelength response of the light sensor and the control method thereof according to the second embodiment of the present application;

FIG. 5 shows a schematic diagram of the architecture of the light sensor and the control method thereof according to the third embodiment of the present application;

FIG. 6 shows a schematic diagram of the architecture of the light sensor and the control method thereof according to the fourth embodiment of the present application; and

FIG. 7 shows a schematic diagram of the wavelength response of the light sensor and the control method thereof according to the fourth embodiment of the present application.

### DETAILED DESCRIPTION OF THE INVENTION

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other devices or connecting means indirectly.

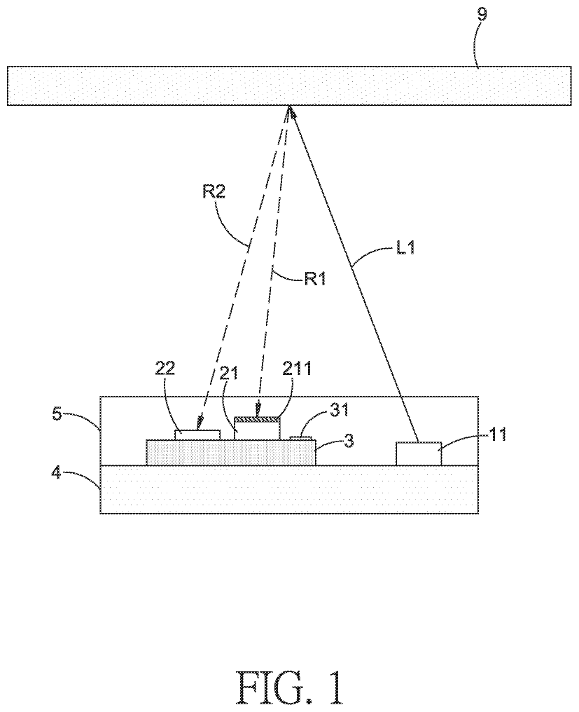

Please refer to FIG. 1, which shows a schematic diagram of the architecture of the light sensor and the control method thereof according to the first embodiment of the present application. The light sensor comprises a light-emitting device 11, a first light-sensing unit 21, and a second light-sensing unit 22. The first light-sensing unit 21 and the second light-sensing unit 22 may be two independent electronic elements. Further, in general, the first light-sensing unit 21 and the second light-sensing unit 22 are integrated on an integrated-circuit chip (hereinafter called a chip) 3. The chip 3 may further include a control unit 31. The control unit 31 may be coupled to the light-emitting device 11, the first light-sensing unit 21, and the second light-sensing unit 22, respectively, for controlling their operations and processing the generated signals. Nonetheless, according to another embodiment of the present application, the control unit 31 may be set in an external device, for example, a mobile communication device or a wearable device, to control the light-emitting device 11, the first light-sensing unit 21, and the second light-sensing unit 22 and process signals. The light-emitting device 11, the first light-sensing unit 21, and the second light-sensing unit 22 may be disposed on a substrate 4. In addition, a transparent molded material 5 may be used to package and protect the chip 3 of the first light-sensing unit 21 and the second light-sensing unit 22. These are normally used structures adopted in proximity sensors. Nonetheless, the present application is not limited to the normally used structures.

It is noteworthy that the light-sensing characteristics of the first light-sensing unit 21 corresponds to a first wavelength range, and the light-sensing characteristics of the second light-sensing unit 22 corresponds to a second wavelength range. Further, the first wavelength range is different from the second wavelength range. To elaborate, to correspond the light-sensing characteristics of the first light-sensing unit 21 and the second light-sensing unit 22 to different wavelength ranges, different optoelectronic diodes may be selected. Nonetheless, in practice, other methods are adopted for lower cost. For example, according to the present embodiment, even identical optoelectronic diodes are adopted to fabricate the first light-sensing unit 21 and the second light-sensing unit 22, an optical filter 211 may be disposed on the first light-sensing unit 21 and covering the light-receiving region of the first light-sensing unit 21. The optical filter 211 may alter the light-sensing characteristics of the first light-sensing unit 21. Contrarily, according to the present embodiment, the second light-sensing unit 22 may include no optical filter. Thereby, the light-sensing characteristics of the second light-sensing unit 22 will not be influenced by the optical filter. Consequently, the first light-sensing unit 21 and the second light-sensing unit 22 may have different light-sensing characteristics corresponding to different wavelength ranges.

The optical filter 211 may be formed on the first light-sensing unit 21 by stacking different materials. For example, the optical filter 211 may be fabricated by coating a single or multiple layers of film or by using optical microstructures. Alternatively, the optical filter 211 may be formed by doping dyes in the original structure, for example, the lens, of the first light-sensing unit 211. Of course, the optical filter 211 may be the combination of the above two structures.

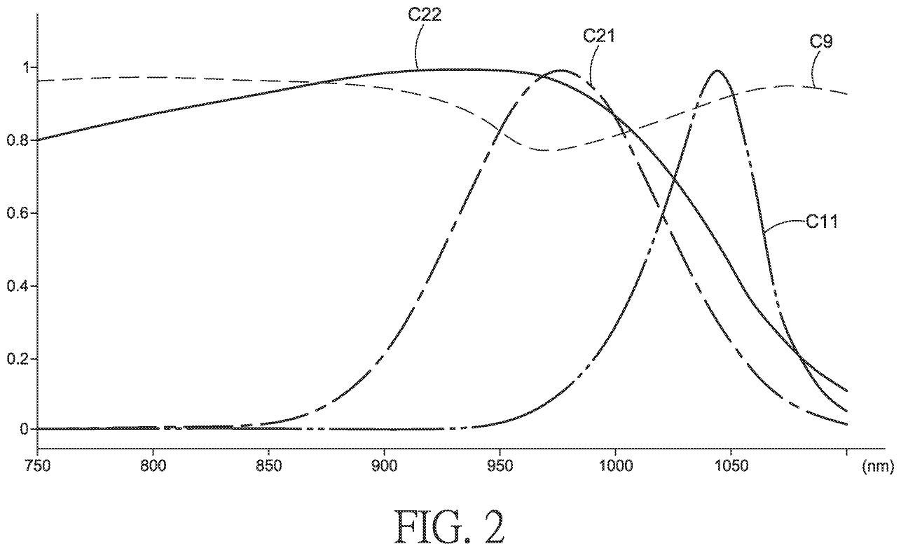

Hereby, please refer to FIG. 2 with a combination of the above embodiment, in which FIG. 2 shows a schematic diagram of the wavelength response of the light sensor and the control method thereof according to the first embodiment of the present application. In which, the curve C11 represents the wavelengths related to the emitted signal L1 of the light-emitting device 11; the curve C21 represents the light-sensing characteristics of the first light-sensing unit 21; and the curve C22 represents the light-sensing characteristics of the second light-sensing unit 22. By comparing the curves C21 and C22, it may be observed that the wavelength range of the first light-sensing unit 21 having the optical filter 211 is around 900˜1050 nm, while the wavelength range of the second light-sensing unit 22 without the optical filter may be extended to be less than 750 nm and higher than 1050 nm. When an object 9 is approaching the light sensor, the emitted signal L1 generated by the first light-emitting device 11 will be reflected by the object 9 to form a first reflection signal R1 and a second reflection signal R2 in the meanwhile. Thereby, the first reflection signal R1 is received by the first light-sensing unit 21, and, in the meanwhile, the second reflection signal R2 is received by the second light-sensing unit 22. According to the embodiment of the present application, the proximity sensing may be performed according to the first reflection signal R1 sensed by the first light-sensing unit 21 or the second reflection signal R2 sensed by the second light-sensing unit 22. In other words, the control unit 31 may perform proximity sensing according to the first reflection signal R1 sensed by the first light-sensing unit 21 independently. Alternatively, the control unit 31 may perform proximity sensing according to the second reflection signal R2 sensed by the second light-sensing unit 22 independently. Moreover, the proximity sensing may be performed according to a combination of the first reflection signal R1 sensed by the first light-sensing unit 21 and the second reflection signal R2 sensed by the second light-sensing unit 22. Since proximity sensing is one of the major functions of the proximity sensors according to the prior art, the operation details of proximity sensing will not be described here.

Here should be noted, in the first embodiment, the light sensor and the control method thereof according to the present application how to judge the type of the object 9 according to the sensed signals of the first light-sensing unit 21 and the second light-sensing unit 22. In FIG. 2, the curve C9 shows the reflectivity of the object 9 for light with different wavelengths. Here, the object 9 is the human skin for example. It may be observed that the reflectivity of the object 9 is lower around the wavelength 970 nm. This is because, in general, the absorptivity of water is higher around the wavelength 970 nm. Different types of objects (for example, the human skin and other objects) own different water content. Thereby, the reflectivity of the objects will be different around the wavelength 970 nm. If the object 9 is replaced by another one with higher or lower water content, the reflectivity curve will be different from the curve C9 as shown in the figure. The above embodiment is only a simple description. In practice, the factor influencing the reflectivity is not only water content. To know the reflectivity of various objects for different wavelengths, a person having ordinary skill in the art may acquire the information through limited number of experiments.

According to different properties for the reflectivity of different objects and the light-sensing characteristics of the first and second light-sensing units 21, 22 corresponding to different wavelength ranges according to the first embodiment of the present application, the sensed signals of the first and second light-sensing units 21, 22 may be used to judge the type of the object 9. To elaborate, since the wavelength range corresponding to the light-sensing characteristics of the first light-sensing unit 21 according to the present embodiment is roughly between 900 and 1050 nm, the components of the light reflected by the object 9 around the wavelength 970 nm may be majorly represented. In contrast, the wavelength range corresponding to the light-sensing characteristics of the second light-sensing unit 22 is extended to a broader range. Its sensitivity for the reflection light from the object 9 around the wavelength 970 nm will be less than the sensitivity of the first light-sensing unit 21. Thereby, according to the difference between the sensed signals of the first and second light-sensing units 21, 22, the type of the object 9 may be judged.

The control unit 31 may produce an identification rate K according to the difference between the sensed signals of the first light-sensing unit 21 and the second light-sensing unit 22. If the value of the sensed signal of the first light-sensing unit 21 after analog-to-digital conversion is Code_21 and the value of the sensed signal of the second light-sensing unit 22 after analog-to-digital conversion is Code_22, the above identification rate K may be simply defined as the ratio between Code_21 and Code_22. Nonetheless, to enlarge the value difference for identification rate K corresponding to various objects, users may redefine the identification rate K by, for example, multiplying specific coefficients or arithmetic operations. For a simple example, the identification rate K may be defined as the following equation (1):

$$K = \frac{Code\_ 22 - Code\_ 21}{Code\_ 22 + Code\_ 21} \qquad ( 1 )$$

The following table shows the light sensor and the control method thereof according to the present embodiment. When different types of object samples approach, according to the normalized identification rate using equation (1), it may be observed that the identification rates K′ of different colors of human skin are approximately around 94%˜107% and the identification rates K′ of other objects are not within the range. Thereby, the identification rate K′ 94%˜107% may be adopted as the index stored in the control unit 31 or coupled to an external system. Hence, the light sensor and the control method thereof according to the present embodiment may judge if the object 9 is human skin.

| Object sample | K′ | Object sample | K′ |
|---|---|---|---|
| Light human skin | 94% | Green cucumber | 159% |
| Medium human skin | 98% | White cucumber | 133% |
| Darlk human skin | 107% | Green tomato | 154% |
| Water | 147% | Yellow tomato | 84% |
| Doll | 361% | Aubergine | 123% |
| Color card | 221% | | |

It should be stressed that although the human skin is the target to be identified according to the present embodiment, a person having ordinary skill in the art may read the above description and apply the same principle to design the light sensor for identifying other types of objects, instead of being limited to identifying human skin.

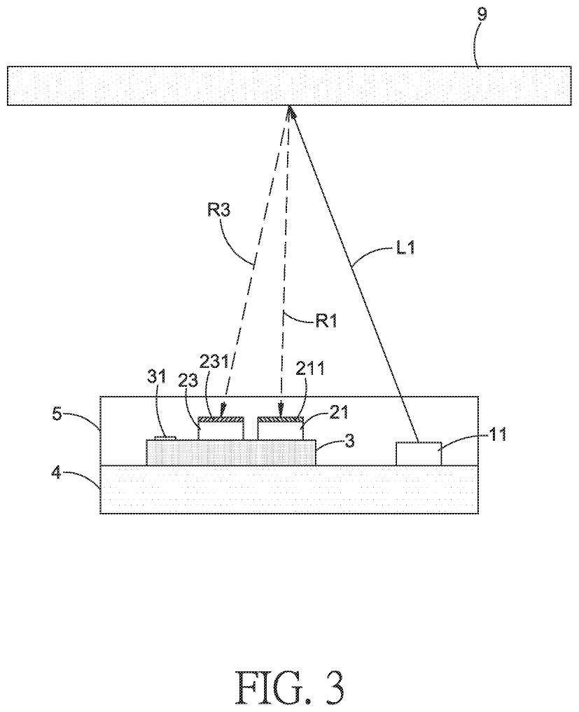

In the following, various embodiment of the light sensor and the control method thereof according to the present application will be described sequentially. Please refer to FIG. 3, which shows a schematic diagram of the architecture of the light sensor and the control method thereof according to the second embodiment of the present application. The difference between the second embodiment and the first one is that, according to the first embodiment, the second light-sensing unit 22 includes no optical filter. According to the present embodiment, a third light-sensing unit 23 replaces the second light-sensing unit 22. The third light-sensing unit 23 includes an optical filter 231, which covers the light-receiving region of the third light-sensing unit 23. The optical filter 231 may alter the light-sensing characteristics of the third light-sensing unit 23. Nonetheless, the optical filter 231 of the third light-sensing unit 23 may be different from the optical filter 211 of the first light-sensing unit 21. For example, if the optical filters 211, 231 are fabricated by coating films, the coating materials, thickness, and number of layers of the optical filter 211 may be different from those of the optical filter 231. Thus, the light-sensing characteristics of the first and the third light-sensing units 21, 23 correspond to different wavelength ranges.

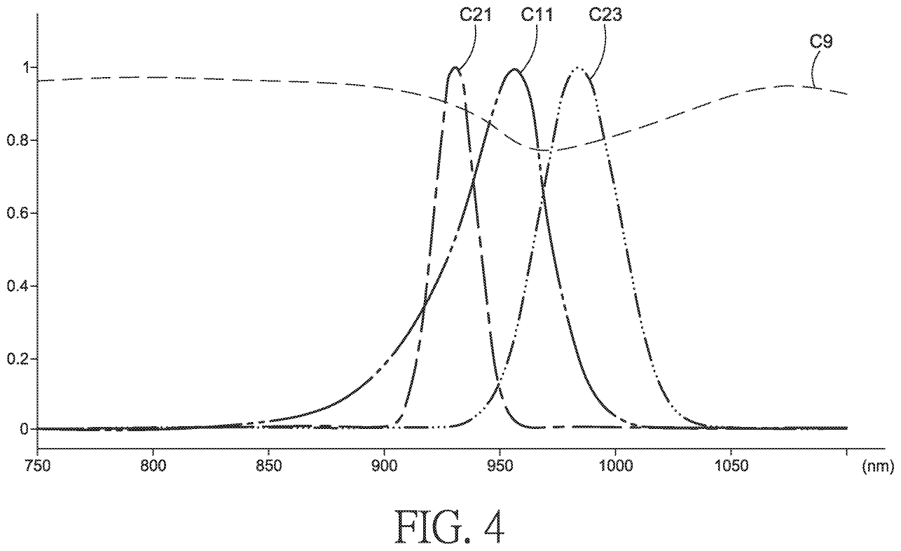

Please refer to FIG. 4, which shows a schematic diagram of the wavelength response of the light sensor and the control method thereof according to the second embodiment of the present application. The curve C11 represents the wavelength response of the emitted signal L1 of the light-emitting device 11; the curve C21 represents the light-sensing characteristics of the first light-sensing unit 21; and the curve C23 represents the light-sensing characteristics of the third light-sensing unit 23. Compare the curves C21, C23, it may be observed that the corresponding wavelength range of the light-sensing characteristics of the first light-sensing unit 21 is around between 900 and 950 nm, while the corresponding wavelength range of the light-sensing characteristics of the third light-sensing unit 23 is around between 950 and 1000 nm. When an object 9 approaches the light sensor, the emitted signal L1 generated by the light-emitting device 11 will be reflected by the object 9 and forming a first reflection signal R1 received by the first light-sensing unit 21 and a third reflection signal R3 received by the third light-sensing unit 23. Likewise, according to the difference between the signals sensed by the first and third light-sensing units 21, 23, the type of the object 9 may be judged.

Similarly, the control unit 31 may produce an identification rate K according to the difference between the signals sensed by the first light-sensing unit 21 and the third light-sensing unit 23. For a simple example, if the value of the signal sensed by the first light-sensing unit 21 after analog-to-digital conversion is Code_21 and the value of the signal sensed by the third light-sensing unit 23 after analog-to-digital conversion is Code_23, the identification rate K may be defined as the following equation (2):

$$K = \frac{Code\_ 23 - Code\_ 21}{Code\_ 23 + Code\_ 21} \qquad ( 2 )$$

The following table shows the light sensor and the control method thereof according to the present embodiment. When different types of object samples approach, according to the normalized identification rate using equation (2), it may be observed that the identification rates K′ of different colors of human skin are approximately around 78%˜135% and the identification rates K′ of other objects are not within the range. Thereby, the identification rate K′ 78%˜135% may be adopted as the index stored in the control unit 31 or coupled to an external system. Hence, the light sensor and the control method thereof according to the present embodiment may judge if the object 9 is human skin.

| Object sample | K′ | Object sample | K′ |
|---|---|---|---|
| Light human skin | 135% | Green cucumber | 47% |
| Medium human skin | 87% | White cucumber | 73% |
| Darlk human skin | 78% | Green tomato | 144% |
| Water | 580% | Yellow tomato | 258% |
| Doll | 180% | Aubergine | 70% |
| Color card | 226% | | |

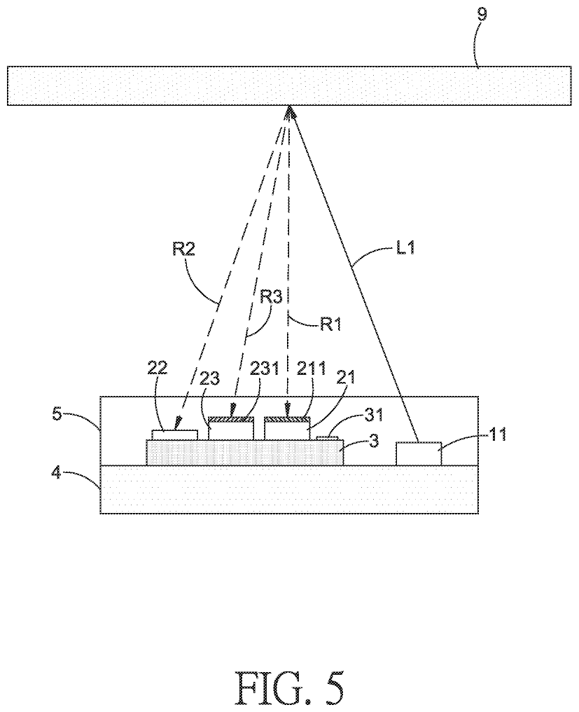

Please refer to FIG. 5, which shows a schematic diagram of the architecture of the light sensor and the control method thereof according to the third embodiment of the present application. The difference between the present embodiment and the first one is that, according to the present embodiment, the third light-sensing unit 23 of the second embodiment is additionally disposed and the light-sensing characteristics of the first, the second, and the third light-sensing units 21, 22, 23 correspond to different wavelength ranges, respectively. Thereby, since there are three or more wavelength ranges, it is convenient for a user to design object judgment according to the differences between the signals sensed by the first, the second, and the third light-sensing units 21, 22, 23.

The control unit 31 may produce an identification rate K according to the differences between the signals sensed by the first, the second, and the third light-sensing units 21, 22, 23. For a simple example, if the value of the signal sensed by the first light-sensing unit 21 after analog-to-digital conversion is Code_21, the value of the signal sensed by the second light-sensing unit 22 after analog-to-digital conversion is Code_22, and the value of the signal sensed by the third light-sensing unit 23 after analog-to-digital conversion is Code_23, the identification rate K may be defined as the following equation (3) with increased design flexibility:

$$K = \frac{Code\_ 23 - ( Code\_ 22 - Code\_ 21 )}{Code\_ 23 + ( Code\_ 22 - Code\_ 21 )} \qquad ( 3 )$$

According to previous embodiments of the present application, the light-emitting device 11 is generally a light-emitting diode or a laser diode. As the curve C11 shown in FIG. 2 and FIG. 4, the wavelength of the emitted signal L1 emitted by the light-emitting device 11 will fall within a wavelength range. In addition, the first, the second, and the third light-sensing units 21, 22, 23 correspond to different wavelength ranges. To sense the reflection signal of the emitted signal L1 from the object 9, once the wavelength ranges of the light-sensing units and the emitted signal L1 differ significantly, the sensing efficiency will be affected. However, this will not be a problem for distance sensing.

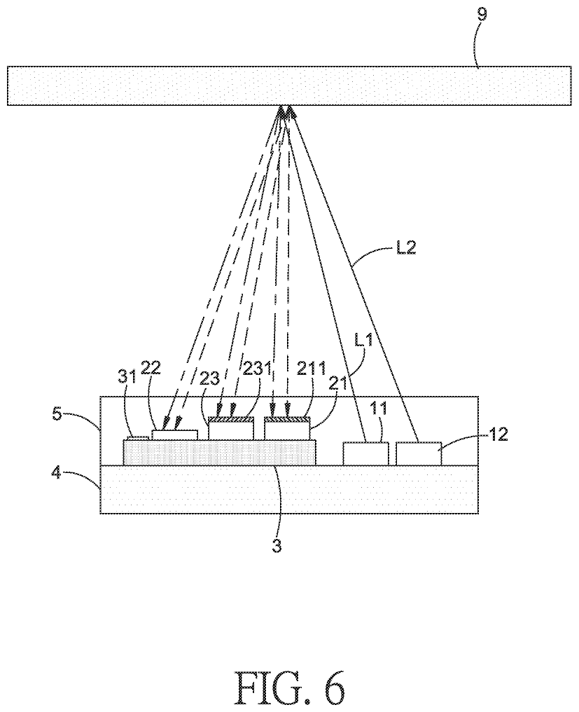

Please refer to FIG. 6, which shows a schematic diagram of the architecture of the light sensor and the control method thereof according to the fourth embodiment of the present application. The difference between the present embodiment and the third embodiment is that, according to the present embodiment, a light-emitting device 12 is further included. For convenience, the original light-emitting device 11 is called the first light-emitting device, while the other light-emitting device 12 is the second light-emitting device. The wavelength of the emitted signal L2 from the first light-emitting device 11 is different from the wavelength of the emitted signal L2 from the second light-emitting device 12.

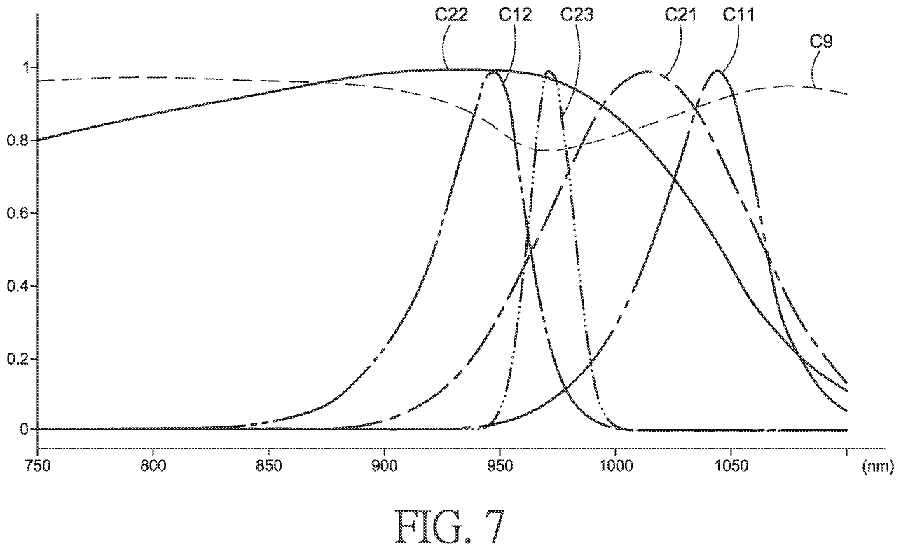

To elaborate, please refer to FIG. 7, which shows a schematic diagram of the wavelength response of the light sensor and the control method thereof according to the fourth embodiment of the present application. The curve C11 represents the wavelength of the emitted signal L1 from the first light-emitting device 11; the curve C12 represents the wavelength of the emitted signal L2 from the second light-emitting device 12; the curve C21 represents the light-sensing characteristics of the first light-sensing unit 21; the curve C22 represents the light-sensing characteristics of the second light-sensing unit 22; and the curve C23 represents the light-sensing characteristics of the third light-sensing unit 23. Compare the curves C21, C23, it may be observed that the optimum wavelength range of the third light-sensing unit 23 is around between 950 and 1000 nm. The proportion of the light for the first light-sensing unit 21 is not high in this wavelength range. Thanks to the second light-emitting device 12, it is ensured that the third light-sensing unit 23 still may maintain sufficient sensing efficiency.

The first light-emitting device 11 and the second light-emitting device 12 may emit the emitted signals L1, L2 simultaneously. They may be combined to form the reflection signal to be received by the light-sensing units. In this case, the operations of the light-sensing units are the same as in the previous embodiment. Nonetheless, because there are two or more light-emitting devices according to the present embodiment, in practice, the control unit 3 may control the first light-emitting device 11 and the second light-emitting device 12 to emit the emitted signals L1, L2 separately. Then the light-sensing units may receive the reflection signals formed by the reflection from the object 9, respectively. The analog-to-digital-converted value of the signal sensed by the first light-sensing unit 21 when the first light-emitting device 11 emits light is represented by Code_211. The analog-to-digital-converted value of the signal sensed by the first light-sensing unit 21 when the second light-emitting device 12 emits light is represented by Code_212. The analog-to-digital-converted value of the signal sensed by the second light-sensing unit 22 when the first light-emitting device 11 emits light is represented by Code_221. The analog-to-digital-converted value of the signal sensed by the second light-sensing unit 22 when the second light-emitting device 12 emits light is represented by Code_222. The analog-to-digital-converted value of the signal sensed by the third light-sensing unit 23 when the first light-emitting device 11 emits light is represented by Code_231. The analog-to-digital-converted value of the signal sensed by the third light-sensing unit 23 when the second light-emitting device 12 emits light is represented by Code_232. For some simple examples, the identification rate K may be calculated by using the following equations (4) or (5):

$$K = \frac{Code\_ 232 - Code\_ 221}{Code\_ 232 + Code\_ 221} \qquad ( 4 )$$

$$K = \frac{Code\_ 232 - ( Code\_ 221 - Code\_ 211 )}{Code\_ 232 + ( Code\_ 221 - Code\_ 211 )} \qquad ( 5 )$$

The following table shows the light sensor and the control method thereof according to the present embodiment. When different types of object samples approach, according to the normalized identification rate using equation (5), it may be observed that the identification rates K′ of different colors of human skin are approximately around 52%˜165% and the identification rates K′ of other objects are not within the range. Thereby, the identification rate K′ 52%˜165% may be adopted as the index stored in the control unit 31 or coupled to an external system. Hence, the light sensor and the control method thereof according to the present embodiment may judge if the object 9 is human skin. In addition, by comparing the operational results given according to the present embodiment with those given according to the previous embodiments, it may be observed that, benefited by the increase in the amount of light-emitting devices and light-sensing units, the identification accuracy for object types is enhanced obviously at the expense of more costs.

| Object sample | K′ | Object sample | K′ |
|---|---|---|---|
| Light human skin | 52% | Green cucumber | 809% |
| Medium human skin | 83% | White cucumber | 676% |
| Darlk human skin | 165% | Green tomato | 739% |
| Water | 1385% | Yellow tomato | 656% |
| Doll | 2009% | Aubergine | 567% |
| Color card | 737% | | |

According to the above embodiments, although the wavelength ranges of the light-emitting devices are different, they are roughly between 300 and 1600 nm. The wavelengths below 700 nm are visible light and suitable for applying to locations not influencing the visual appearance of products, for example, the backside of a smart watch. Furthermore, to judge the types of objects according to the water content, the light-sensing characteristics of the light-sensing units are preferably between 800 and 1100 nm. Nonetheless, in practice, many factors influence the reflectivity of objects. The related parameters should be selected according to the types of objects to be judged.

To sum up, the light sensor and the control method thereof according to the present application comprise a plurality of light-emitting devices having light-sensing characteristics corresponding to different wavelength ranges. The type of an object under test may be judged according to the difference between the signals sensed by the light-sensing units. By adopting the light sensor and the control method thereof according to the present application, a single light sensor is sufficient to judge the proximity and the type of the object. In contrast, according to the prior art, additional capacitor sensors or temperature sensors are required to provide the category information. The present application significantly reduces the overall cost to accomplish the same functions of object proximity sensing and object category identification for satisfying the requirement of the electronic products.

The foregoing description is only embodiments of the present application, not used to limit the scope and range of the present application. Those equivalent changes or modifications made according to the shape, structure, feature, or spirit described in the claims of the present application are included in the appended claims of the present application.

1. A light sensor, comprising:
a light-emitting device, generating an emitted signal;
a first light-sensing unit, having light-sensing characteristics corresponding to a first wavelength range; and
a second light-sensing unit, having light-sensing characteristics corresponding to a second wavelength range, said second wavelength range differing from said first wavelength range;
wherein when said emitted signal is reflected by an object and received by said first light-sensing unit and said second light-sensing unit, a control unit judges the type of said object according to a difference between a sensed signal of said first light-sensing unit and a sensed signal of said second light-sensing unit.

2. The light sensor of claim 1, wherein said control unit performing a proximity sensing according to the signal sensed by said first light-sensing unit or the signal sensed by said second light-sensing unit.

3. The light sensor of claim 1, wherein said first light-sensing unit includes an optical filter covering the light-receiving region of said first light-sensing unit.

4. The light sensor of claim 3, wherein said second light-sensing unit includes an optical filter covering the light-receiving region of said second light-sensing unit; and said optical filter of said second light-sensing unit is different from the optical filter of said first light-sensing unit.

5. The light sensor of claim 1, wherein said first light-sensing unit includes an optoelectronic diode corresponding to said first wavelength range; and said second light-sensing unit includes an optoelectronic diode corresponding to said second wavelength range.

6. The light sensor of claim 1, wherein said light sensor comprises another light-emitting device generating an emitted signal; and the wavelength of said emitted signal generated by said light-emitting device is different from the wavelength of said emitted signal generated by said another light-emitting device.

7. The light sensor of claim 1, wherein said light sensor comprises a third light-sensing unit with light-sensing characteristics corresponding to a third wavelength range different from said first wavelength range and said second wavelength range; and said control unit judges the type of said object according to the differences between the signals sensed by said first light-sensing unit, said second light-sensing unit, and said third light-sensing unit.

8. The light sensor of claim 1, wherein said control unit is coupled to said light-emitting device, said first light-sensing unit, and said second light-sensing unit, respectively.

9. The light sensor of claim 1, wherein said first light-sensing unit, said second light-sensing unit, and said control unit are integrated on an integrated-circuit chip.

10. The light sensor of claim 1, wherein said control unit operates the signals sensed by said first light-sensing unit and said second light-sensing unit for generating an identification rate and stores a range index of said identification rate for judging the type of said object.

11. A control method of light sensor, controlling the operation of a light sensor comprising a light-emitting device, a first light-sensing unit, and a second light-sensing unit, said first light-sensing unit having light-sensing characteristics corresponding to a first wavelength range, said second light-sensing unit having light-sensing characteristics corresponding to a second wavelength range, said first wavelength range different from said second wavelength range, and comprising steps of:
a control unit controlling said light-emitting device to emit light; and
said control unit receiving the signals sensed by said first light-sensing unit and said second light-sensing unit;
where when said emitted signal is reflected by an object and received by said first light-sensing unit and said second light-sensing unit, said control unit judges the type of said object according to the difference between the signal sensed by said first light-sensing unit and said second light-sensing unit.

12. The control method of light sensor of claim 11, wherein said control unit senses distance according to the signal sensed by said first light-sensing unit or the signal sensed by said second light-sensing unit.

13. The control method of light sensor of claim 11, wherein said light sensor comprises another light-emitting device; and said control method comprises a step of controlling said another light-emitting device to generate an emitting signal and controlling the wavelength of said emitted signal generated by said light-emitting device different from the wavelength of said emitted signal generated by said another light-emitting device.

14. The control method of light sensor of claim 11, wherein said light sensor comprises a third light-sensing unit with light-sensing characteristics corresponding to a third wavelength range different from said first wavelength range and said second wavelength range; and said control method comprises a step of said control unit judging the type of said object according to the differences between the signals sensed by said first light-sensing unit, said second light-sensing unit, and said third light-sensing unit.

15. The control method of light sensor of claim 11, wherein said control unit operates the signals sensed by said first light-sensing unit and said second light-sensing unit for generating an identification rate and stores a range index of said identification rate for judging the type of said object.
